(19) United States
(12) Patent Application Publication
(10) Pub. No.: US 2003/0116259 A1
(43) Pub. Date: Jun. 26, 2003

(54) Method for creping nonwoven webs

(76) Inventors: John Joseph Sayovitz, Marietta, GA (US); Gregory Todd Sudduth, Cumming, GA (US); Charles Edward Edmundson, Roswell, GA (US); Howard Martin Welch, Woodstock, GA (US); Stephen Michael Campbell, Winneconne, WI (US); Wendy Marie Takken, Canton, GA (US); James Randall Morgan, Neenah, WI (US); Cherie Hartman Everhart, Alpharetta, GA (US); Jason Douglas Hadley, Ashevill, NC (US); Susan Elaine Shawver, Roswell, GA (US)

Correspondence Address: KIMBERLY-CLARK WORLDWIDE, INC., 401 NORTH LAKE STREET, NEENAH, WI, 54956

(21) Appl. No.: 10/026,178

(22) Filed: Dec. 20, 2001

(51) Int. Cl. B31F 1/12; D21H 11/00; D21H 13/00; D21H 15/00; D21H 17/00; D21H 19/00; D21H 25/00; D21H 27/00; D21H 21/00; D21H 23/00; B31F 1/14; D04B 1/18; D03D 7/00; D06H 7/10; D04B 7/16; D04B 11/12; D03D 15/08; D03D 17/00; D06C 21/00; D04B 21/18; D06C 23/04; D04B 23/06

(52) U.S. Cl. 156/183; 162/111; 264/283; 28/155

(57) ABSTRACT

The present invention provides a method for creping a nonwoven web using a hot melt adhesive as the creping adhesive. As a second aspect of the present invention, an internal adhesive is added to the polymers used to produce the nonwoven web during the nonwoven web forming process and this internal adhesive adheres the nonwoven web to the creping roll. Using the processes of the present invention, more energy efficient methods are provided for creping nonwoven webs. The creped nonwoven webs of the present invention are useful in a wide variety of application including as wipes, liners, transfer or surge layers, outercovers, other fluid handling materials and looped attachment materials for hook and loop fasteners.

### FIELD OF INVENTION

The present invention relates to a method for creping nonwoven fibrous webs from a creping roll or drum.

### BACKGROUND OF THE INVENTION

Creping is a process in which a nonwoven fibrous web is adhered to a surface of a roll or drum using an adhesive and the adhered nonwoven web is mechanically removed from the surface of the roll or drum. This mechanical removing of the adhered nonwoven web debonds and disrupts the fibers within the nonwoven web, thereby increasing the absorbency, if absorbent fibers are used, softness, and bulk of the nonwoven web. Creping has also been used in the paper making art.

Traditionally in creping processes, water-based adhesives, such as latex adhesives, have been used to attach a nonwoven fibrous web to a creping roll or creping drum. Water-based adhesives require removal of the water from the adhesive by drying before the nonwoven fibrous web can be properly adhered to the creping roll or drum so that the nonwoven fibrous web can be creped from the creping roll or drum. Typically, large heated rolls or drums, such as a Yankee Roll, are required to effectively remove most or all of the water from the water-based adhesive. These drums typically have a high capital cost to install and require a large expenditure of energy to operate and effectively dry the water-based adhesive used in the creping process.

In addition to having high installation cost and high energy cost to operate, using a water-based adhesive also results in slower line speeds due to the time necessary to effectively dry the water-based adhesives. Further, the temperature used to dry the water-based adhesive may have an adverse effect on the thermoplastic polymer fibers of the nonwoven webs which are to be creped.

Water-based adhesives are generally hydrophilic. Therefore, the resulting creped nonwoven web will have some hydrophilic properties. There is a need in the art to provide a thermoplastic nonwoven web which is creped and has hydrophobic properties.

Creped thermoplastic nonwoven webs are known in the art. For example, see U.S. Pat. No. 3,665,921, U.S. Pat. No. 3,668,054, U.S. Pat. No. 3,687,754, U.S. Pat. No. 3,694,867, U.S. Pat. No. 3,705,063, and U.S. Pat. No. 3,705,065, all issued to Stumpf, and hereby incorporated by reference in their entirety. In each of the above-mentioned patents to Stumpf, a high loft nonwoven web having a multiplicity of looped fibers is produced. The Stumpf patents do not teach the use of a hot melt adhesive or an internal adhesive to adhere the nonwoven web to the creping drum.

U.S. Pat. No. 4,810,556, issued to Kobayashi et al. discloses a process of producing a creped nonwoven web by coating an uncreped nonwoven fabric with a lubricant and then pressing the nonwoven fabric between a drive roll and a plate having a rough surface. The plate is positioned near the drum and is substantially parallel or tangential to the outer surface of the drum. The nonwoven web is crinkled in a wavelike fashion in the direction of movement by the frictional force caused by the pressing. The resulting nonwoven is creped, which contributes to the softness of the nonwoven web.

In addition, creped thermoplastic nonwoven webs are also described in WO 99/22619, and U.S. Pat. No. 6,197,404 issued to Verona, both assigned to Kimberly-Clark Worldwide, Inc and hereby incorporated by reference in their entirety. The creped nonwoven web of WO '619 and US '404 has a permanent crepe, wherein regions of interfilament bonding, which are permanently bent out-of-plane, are alternated with regions of no interfilament bonding. In the process disclosed in WO '619 and U.S. '404, a doctor blade is used to crepe the nonwoven fabric from the creping roll. The adhesives disclosed in WO '619 and US '404 are water-based adhesives which require drying before creping. It is noted that one side of the nonwoven web is treated with an adhesive which is hydrophilic and the other side of the web is treated with an adhesive which is hydrophobic. In any event, both adhesives are water-based adhesive which results in a creping process with the disadvantages disclosed above.

Therefore, there is a long felt need in the art for a more energy efficient way to produce creped nonwoven fibrous webs containing thermoplastic fibers, and/or an efficient way to produce creped nonwoven webs which are hydrophobic containing thermoplastic fibers.

### SUMMARY OF THE INVENTION

The present invention provides an improved method of producing creped nonwoven fibrous webs derived from thermoplastic polymers. The process of the present invention provides an effective method of creping thermoplastic nonwoven webs without the disadvantages of having to dry the creping adhesive prior to removal of the nonwoven web from the creping roll.

The present invention also provides a method of creping nonwoven webs using a smooth roll rather than a Yankee Drum. This can lessen the capital cost of building a creping line as well as reduce the operational cost associated with operating a Yankee Drum.

In a further aspect of the present invention, the method of the present invention allows the formation of creped nonwoven webs without adversely affecting the properties of the web due to the application of heat needed to remove water from a latex adhesive. In addition, the method of the present invention also provides a method of creping a nonwoven web without rendering the nonwoven web hydrophilic, due to the application of a water-based adhesive, either directly or indirectly, to adhere the nonwoven web to the creping roll or drum.

In an embodiment of the present invention, a method for producing a creped nonwoven web containing thermoplastic fibers is provided. The method comprises

a) providing a nonwoven fibrous web having a first side and a second side, wherein the nonwoven fibrous web comprises thermoplastic fibers;

b) adhering the first side of the nonwoven fibrous web to a first roll by contacting the nonwoven fibrous web with the first roll using a hot melt adhesive to adhere the nonwoven fibrous web to the first roll; and

c) removing nonwoven fibrous web adhered to the first roll by creping the nonwoven fibrous web from the first roll with a creping blade to produce a creped thermoplastic nonwoven web.

In another embodiment of the present invention, another method for producing a creped nonwoven web containing thermoplastic fibers is provided. The method comprises

a) providing an adhesive nonwoven fibrous web having a first side and a second side comprising thermoplastic fibers wherein the thermoplastic fibers comprise a thermoplastic polymer and an adhesive additive;

b) adhering the first side of the adhesive nonwoven fibrous web to a first roll by contacting the adhesive nonwoven fibrous web with the first roll; and

c) removing nonwoven fibrous web adhered to the first roll by creping the nonwoven fibrous web from the first roll with a creping blade to produce a creped thermoplastic nonwoven web.

In further embodiments of the present invention, both sides of the nonwoven web containing thermoplastic fibers are creped. In these further embodiments, the second side of the nonwoven web is adhered to a second roll. If the nonwoven fibrous web is prepared from a thermoplastic polymer and an adhesive additive, the second side of the adhesive, once creped nonwoven fibrous web can be adhered to the second roll. In the alternative, if an adhesive additive is not present in the thermoplastic polymer, a hot melt adhesive is used to adhere the second side of the nonwoven fibrous web to the roll. The nonwoven fibrous web adhered to the second roll is removed by creping the nonwoven fibrous web from the second roll with a creping blade to produce a creped thermoplastic fiber containing nonwoven web which is creped on both the first and second sides.

### BRIEF DESCRIPTION OF THE DRAWINGS

FIG. 1 generally shows a schematic diagram of the apparatus used to practice the methods of the present invention to crepe one side of a nonwoven fibrous web.

FIG. 2 generally shows methods and apparatus to apply a hot melt adhesive in the practice of the present invention.

FIG. 3 generally shows a schematic diagram of the apparatus used to practice the methods of the present invention to crepe both sides of a nonwoven fibrous web.

### DEFINITIONS

As used herein, the term “nonwoven fibrous web” or “nonwoven web” means a web having a structure of individual fibers or threads which are interlaid, but not in an identifiable manner as in a knitted web. Nonwoven webs have been formed from many processes, such as, for example, meltblowing processes, spunbonding processes, airlaid processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman; U.S. Pat. No. 3,542,615 to Dobo et al.; and U.S. Pat. No. 5,382,400 to Pike et al.; the entire content of each is incorporated herein by reference. Spunbond fibers are generally not tacky when they are deposited onto a collecting surface. Spunbond fibers are generally continuous and have average diameters (from a sample of at least 10) larger than 7 microns, more particularly, between about 10 and 40 microns.

As used herein the term “meltblown fibers” means fibers of polymeric material which are generally formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter. Thereafter, the meltblown fibers can be carried by the high velocity gas stream and are deposited on a collecting surface to form a web of randomly dispersed meltblown fibers. Such a process is disclosed, for example, in U.S. Pat. No. 3,849,241 to Butin et al., which is hereby incorporated by reference in its entirety. Meltblown fibers may be continuous or discontinuous, are generally smaller than 10 microns in average diameter, and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “conjugate fibers” refers to fibers or filaments which have been formed from at least two polymers extruded from separate extruders but spun together to form one fiber. Conjugate fibers are also sometimes referred to as multicomponent or bicomponent fibers filaments. The polymers are usually different from each other though conjugate fibers may be monocomponent fibers. The polymers are arranged in substantially constantly positioned distinct zones across the cross-section of the conjugate fibers or filaments and extend continuously along the length of the conjugate fibers or filaments. The configuration of such a conjugate fiber may be, for example, a sheath/core arrangement, wherein one polymer is surrounded by another, a side-by-side arrangement, a pie arrangement or an “islands-in-the-sea” arrangement. Conjugate fibers are taught in U.S. Pat. No. 5,108,820 to Kaneko et al., U.S. Pat. No. 5,336,552 to Strack et al., and U.S. Pat. No. 5,382,400 to Pike et al., the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random.

The term “blend”, as used herein, means a mixture of two or more polymers while the term “alloy” means a sub-class of blends wherein the components are immiscible but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

As used herein, the phrase “nonwoven web bond pattern” is a pattern of interfilament bonding in the nonwoven web which is imparted during manufacture of the nonwoven web.

As used herein, the term “microfibers” means small diameter fibers having an average diameter not greater than about 100 microns, for example, having an average diameter of from about 0.5 microns to about 50 microns, or more particularly, an average diameter of from about 4 microns to about 40 microns.

As used herein, the term “hydrophilic” refers to a surface or material that has an affinity for water, and is wettable by water. Some hydrophilic materials are capable of absorbing water, dissolving in water, and/or swelling.

As used herein, the term “hydrophobic” refers to a surface or material that is poorly wetted by water, has little or no affinity for water, and tends to repel water.

As used herein, through-air bonding or “TAB” means a process of bonding a nonwoven fiber web in which air, which is sufficiently hot to melt one of the polymers of which the fibers of the web are made, is forced through the web. The air velocity is between 100 and 500 feet per minute and the dwell time may be as long as 10 seconds. The melting and resolidification of the polymer provides the bonding. Through-air bonding has relatively restricted variability and since through-air bonding requires the melting of at least one component to accomplish bonding, it is generally restricted to webs with two components like multicomponent fibers or those which include an adhesive. In the through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component and thereby forms bonds between the filaments to integrate the web.

As used herein “thermal point bonded” means bonding one or more fabrics with a pattern of discrete bond points. As an example, thermal point bonding often involves passing a fabric or web of fibers to be bonded between a pair of heated bonding rolls (calendering rolls). One of the bonding rolls is usually, though not always, patterned in some way so that the entire fabric is not bonded across its entire surface, and the second or anvil roll is usually a smooth surface. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern, having generally alternating perpendicular segments, with about a 19% bond area. Typically, the percent bonding area varies from around 10% to around 30% of the area of the fabric laminate web. Point bonding may be used to hold the layers of a laminate together and/or to impart integrity to individual layers by bonding filaments and/or fibers within the web.

As used herein “pattern unbonded” or interchangeably “point unbonded” or “PUB”, means a fabric pattern having continuous bonded areas defining a plurality of discrete unbonded areas. The fibers or filaments within the discrete unbonded areas are dimensionally stabilized by the continuous bonded areas that encircle or surround each unbonded area, such that no support or backing layer of film or adhesive is required. The unbonded areas are specifically designed to afford spaces between fibers or filaments within the unbonded areas. A suitable process for forming the pattern-unbonded nonwoven material of this invention includes providing a nonwoven fabric or web, providing opposedly positioned first and second calender rolls and defining a nip there between, with at least one of the rolls being heated and having a bonding pattern on its outermost surface comprising a continuous pattern of land areas defining a plurality of discrete openings, apertures or holes, and passing the nonwoven fabric or web within the nip formed by the rolls. Each of the openings in the roll or rolls defined by the continuous land areas forms a discrete unbonded area in at least one surface of the nonwoven fabric or web in which the fibers or filaments of the web are substantially or completely unbonded. Stated alternatively, the continuous pattern of land areas in the roll or rolls forms a continuous pattern of bonded areas that define a plurality of discrete unbonded areas on at least one surface of the nonwoven fabric or web. The PUB pattern is further described in U.S. Pat. No. 5,858,515 to Stokes et al, the entire contents of which are hereby incorporated by reference.

“Creped” refers to a bonded nonwoven web having portions which are bent out-of-plane using a variety of creping techniques known in the art. Creped nonwoven webs have top and/or bottom surfaces which define a three-dimensional structure. The three-dimensional structure is manifested in the form of puckering, waves, peaks and valleys, etc., so that some regions of the nonwoven web are substantially elevated or depressed relative to adjacent regions.

“Permanently creped” refers to a creped nonwoven web having bonded and unbonded areas, in which the bonded areas are permanently bent out-of-plane and the unbonded portions are permanently looped, such that the nonwoven web cannot be returned to its original uncreped state by applying a mechanical stress, such as may be encountered during further processing or use conditions.

“Crepe level” is a measure of creping and is calculated according to the following equation:

$$Crepe level ( \% ) = \frac{\begin{matrix}Speed of Creping Surface minus speed \\ of windup reel for the creped web\end{matrix}}{Speed of Creping Surface} \times 100$$

“Bent out-of-plane” refers to a bonding or orientation of portions of the nonwoven web in a direction away from the plane in which the nonwoven web substantially lies before being subjected to the creping process. As used herein, the phrase “bent out-of-plane” generally refers to nonwoven webs having creped portions bent at least about 15 degrees away from the plane of the uncreped nonwoven web, preferably at least about 30 degrees.

“Looped” refers to unbonded filaments or portions of filaments in a creped nonwoven web which define an arch, semi-circle or similar configuration extending above the plane of the uncreped nonwoven web, and terminating at both ends in the nonwoven web (e.g., in the bonded areas of the creped nonwoven web).

### DETAILED DESCRIPTION OF THE INVENTION

The methods of the present invention are for the preparation of a creped thermoplastic fiber containing nonwoven web.

A first method of the present invention for preparing a creped nonwoven web containing thermoplastic fibers is accomplished by

a) providing a nonwoven fibrous web having a first side and a second side, wherein the nonwoven fibrous web contains thermoplastic fibers;

b) adhering the first side of the nonwoven fibrous web to a first creping roll by contacting the nonwoven fibrous web with the first creping roll using a hot melt adhesive to adhere the nonwoven fibrous web to the first creping roll; and

c) removing nonwoven fibrous web adhered to the first creping roll by creping the nonwoven fibrous web from the first creping roll with a creping blade to produce a creped nonwoven web.

In the practice of the present invention, any thermoplastic polymer can be used to produce the nonwoven fibrous web. The selection of the thermoplastic polymer is not critical to the present invention. The polymers suitable for the present invention include polyolefins, polyesters, polyamides, polycarbonates, polyurethanes, polyvinylchloride, polytetrafluoroethylene, polystyrene, polyethylene terephathalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 40, 25 and 12, respectively. Fiber forming polypropylenes include Exxon Chemical Company's ESCORENE PD3445 polypropylene. Many other polyolefins are commercially available and generally can be used in the present invention. The particularly preferred polyolefins are polypropylene and polyethylene.

Metallocene-catalyzed polyolefins are also useful, including those described in U.S. Pat. Nos. 5,571,619; 5,322,728; and 5,272,236, the disclosures of which are incorporated herein by reference. Polymers made using metallocene catalysts have a very narrow molecular weight range. Polydispersity numbers (Mw/Mn) of below 4 and even below 2 are possible for metallocene-produced polymers. These polymers also have a controlled short chain branching distribution compared to otherwise similar Ziegler-Natta produced type polymers. It is also possible using a metallocene catalyst system to control the isotacticity of the polymer quite closely.

Any manufacturing process known to those skilled in the art can be used to produce nonwoven fibrous webs of thermoplastic fibers which are creped in accordance with the process of the present invention. These manufacturing processes include, but are not limited to, the spunbond process, the airlaid process, the carded web process and the meltblown process. In addition, the fibers making up the nonwoven web can be prepared from monocomponent fibers, conjugate fibers, multiconsituent fibers and blends of fibers.

In addition, multilayer laminates of nonwoven fibrous webs can also be used in the practice of the present invention. The multilayer laminate may be formed by a number of different techniques, including but not limited to, using an adhesive, needle punching, ultrasonic bonding, thermal calendering and through air bonding. Examples of multilayer laminates include laminates wherein some of the layers are spunbond and some of the layers are meltblown, such as a spunbond/meltblown/spunbond (SMS) laminate as disclosed in U.S. Pat. No. 4,041,203 to Brock et al. and U.S. Pat. No. 5,169,706 to Collier et al., each hereby incorporated in their entirety. Generally, the SMS is prepared by depositing a spunbond layer onto a moving conveyor belt or forming wire, then a meltblown layer is deposited onto the spunbond layer and a second spunbond layer is deposited onto the meltblown layer. Once all of the layers are deposited, the laminate is bonded in a manner described above. Other laminates include a spunbond/spunbond laminate made by sequentially depositing spunbond layers onto a moving conveyor belt or forming wire and bonding the resulting laminate. As an alternative process, laminates can be prepared by first preparing each of the layers individually and collecting the layer on rolls. The rolls are then loaded onto another machine which unrolls each of the layer and laminates the layers together using a bonding method described above.

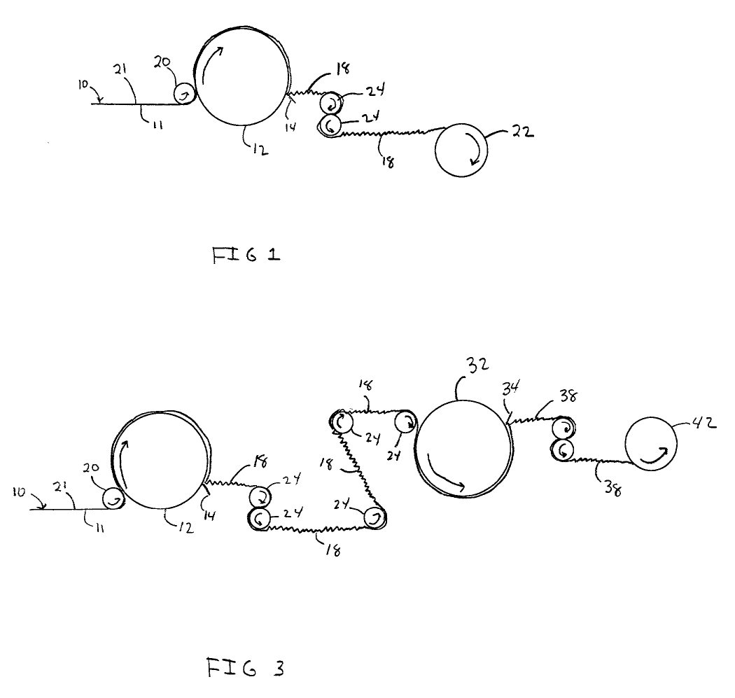

FIG. 1 shows a general schematic for practicing the present invention. A nonwoven web 10, having a first side 11 and a second side 21, is supplied to the process of the present invention either directly from the nonwoven web formation process or from a roll of the nonwoven web. When the nonwoven web is supplied directly from the nonwoven web formation process to the creping process shown in FIG. 1, this process will hereinafter be referred to as an “in-line process”. When the nonwoven web is supplied from a roll to the process shown in FIG. 1, this process will hereinafter be referred to as “off-line process”. It is not critical to the present invention whether the creping process is in-line or off-line.

A press roll 20 engages the first side 11 of the nonwoven web 10 with the creping roll 12 by guiding the nonwoven web 10 onto the creping roll 12. The press roll 20 also supplies sufficient pressure to the nonwoven web 10 to adhere the nonwoven web 10 to the creping roll 12.

In the first method of the present invention, a hot melt adhesive is used to adhere the nonwoven fibrous web 10 to the creping roll 12. Hot melt adhesives typically exist as solid masses at ambient temperature and can be converted to a flowable liquid by the application of heat. By definition, a hot melt adhesive does not contain a liquid carrier and can be formulated to be tacky when in the molten state. In addition, hot melt adhesives can be formulated to be tacky at room temperature. The room temperature tacky hot melt adhesives are sometimes referred to as “pressure sensitive adhesives”. Hot melt adhesives have been used in manufacturing of a wide variety of disposable goods where bonding of various substrates is often necessary. For example, specific applications include nonwoven fabric containing products, such, as disposable diapers, hospital pads, sanitary napkins, surgical drapes and adult incontinent briefs, etc. In these applications, the hot melt adhesive is heated to its molten state and then applied to a substrate. A second substrate is then brought into contact with and compressed against the first substrate. The adhesive solidifies on cooling to form a strong bond between the substrates. One major advantage of hot melt adhesives is the lack of a liquid carrier, as would be the case of water or solvent based adhesives, thereby eliminating costly processes associated with liquid carrier removal.

Hot melt adhesives are generally heated to a temperature at least to the melting point of the hot melt adhesive. Generally, the melt point of hot melt adhesives is above ambient temperature and is often in the range of about 60° C. to about 200° C. Many different commercially available hot melt adhesive compositions can be used in the present invention. It will be apparent to those skilled in the art which hot melt adhesives can be used in the creping process of the present invention. It is preferred, although not required, that the hot melt adhesive is prepared from hydrophobic materials. When a hot melt adhesive is hydrophobic, the resulting creped nonwoven web will tend to have hydrophobic properties. It is also preferred that the hot melt adhesive has a relativity low melting point, generally in the range of about 60° C. to about 125° C., since higher melting point hot melt adhesives may detrimentally affect the thermoplastic nonwoven fibrous web, in particular, melt the fibers of the nonwoven fibrous web. Examples of preferred hot melt adhesives include, but are not limited to, styrene/rubber block copolymers, polybutylene, EVA (ethylene/vinyl acetate copolymer), polyester, polyamide, or olefin based adhesives. Commercial examples of hot melt adhesives usable in the present include, but are not limited to, RT2115, RT 2130, RT 2315, RT2330 and RT 2730 available from Huntsman Polymer Corporation of Odessa, Tex., H2525A, and H2096 available from Bostick-Findley Corp of Wauwatosa, Wash. NS5610 and NS34-2950 available from National Starch and Chemical Company of Bridgewater, N.J., and Shell 8911 available from Shell Chemical, Houston Tex.

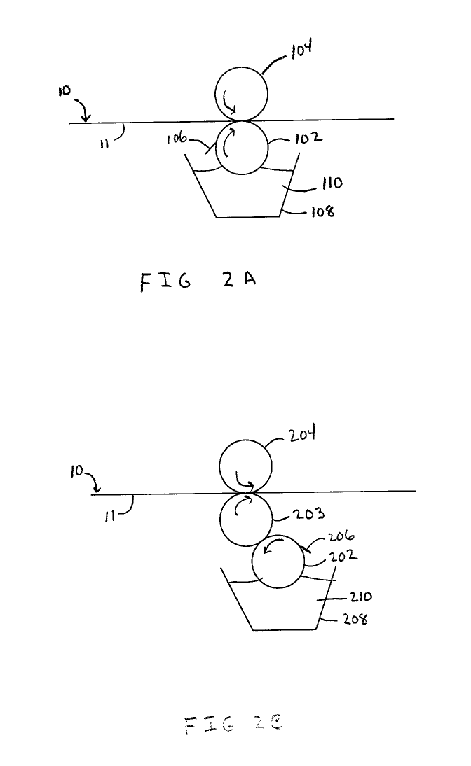

In the process of the present invention, the hot melt adhesive can be applied to the nonwoven fibrous web 10 or to the creping roll 12. It is not critical to the present invention if the hot melt adhesive is applied to the nonwoven web or the creping roll. Any known method of applying hot melt adhesive to the creping roll or nonwoven fibrous web can be used. Examples of suitable methods for applying the hot melt adhesive include, but are not limited to, printing, meltblowing, melt spraying, dripping, splattering or any other technique capable of forming a partial or total adhesive coverage on the thermoplastic nonwoven web or the creping roll. Of the known methods for applying the hot melt adhesive, melt spraying and printing are preferred; however it is not critical to the present invention how the hot melt adhesive is applied to the nonwoven web 10 or creping roll 12. For example, the hot melt adhesive may be sprayed onto the nonwoven fibrous web or onto the creping roll using hot melt spray methods known to those skilled in the art. In the alternative, the hot melt adhesive may be wiped onto the nonwoven fibrous web or the creping roll. In another example, the hot melt adhesive may be applied to the nonwoven fibrous web or the creping roll using a rotogravure applicator roll or a rotogravure offset applicator roll. These rotogravure processes are shown in FIG. 2, which will be discussed in more detail below. FIG. 2A shows using a rotogravure applicator roller (also called a “rotogravure roll”) to apply the hot melt adhesive to the nonwoven fibrous web 10. FIG. 2B shows using an offset roller to apply the adhesive to the nonwoven fibrous web 10. FIG. 2C shows using a rotogravure applicator roller to apply the hot melt adhesive to the creping roll 12. FIG. 2D shows using an offset roller to apply the adhesive to the creping roll 12.

In FIG. 2A, a rotogravure applicator roller 102 is in communication with the reservoir 108 containing the hot melt adhesive 110. Although not shown in the FIG. 2A, a heating means is supplied to the hot melt adhesive 110 in the reservoir 108. Any heating means known to those skilled in the art can be used, so long as the hot melt adhesive is liquefied in the reservoir 108. Examples of heating means, include, but are not limited to, radiant heat. Rotogravure roller 102 picks up the liquid hot melt adhesive 110 from the reservoir 108 and carries the hot melt adhesive 110 upward onto the surface of the roller 102 as it rotates. The rotogravure roller 102 then contacts the first side 11 of the nonwoven web 10. A doctor blade 106 is provided to wipe or scrape off excess adhesive from the rotogravure roller 102 and to ensure that the adhesive 110 is uniformly covered on the rotogravure roller 102. Generally, adequate application of the adhesive to the nonwoven web can be obtained by laying the nonwoven web onto the rotogravure roll 102. However, a back-up roll 104 can be used to ensure that nonwoven fibrous web contacts the rotogravure roll 102. Further, the back-up roll 104 can provide a uniform contact pressure between the nonwoven web 10 and the rotogravure roll 102, thereby allowing the adhesive to be applied to the nonwoven web in a uniform coat throughout the length and width of the nonwoven web. The pressure at the nip between the backup roller 104 and the rotogravure roller 102 is selected to be sufficient to provide proper transfer of the adhesive. Excess pressure should be avoided to prevent a substantial reduction in the thickness of the nonwoven web, if the thickness of the nonwoven web is important in its end use.

In FIG. 2B, the hot melt adhesive is applied to the nonwoven be using an offset roll 203. The rotogravure applicator roller 202 is in communication with the reservoir 208 containing the hot melt adhesive 210. As is noted above, although not shown in FIG. 2B, a heating means is supplied to the hot melt adhesive in the reservoir 208. The rotogravure roller 202 picks up and carries the hot melt adhesive 210 upward onto the surface of the roller 202 as it rotates. The rotogravure roller 202 contacts the offset roll 203, which in turn contacts the first side 11 of the nonwoven web 10. A doctor blade 206 is provided to wipe or scrape off excess hot melt adhesive and to ensure that the hot melt adhesive 210 is uniformly covered on the rotogravure roller and the offset roll 203. Generally, adequate application of the hot melt adhesive to the nonwoven web can be obtained by laying the nonwoven web onto the offset roll 203. However, a back-up roll 204 can be used to ensure that nonwoven fibrous web contacts the offset roll 203. Further, the back-up roll 204 can provide a uniform contact pressure between the nonwoven web 10 and the offset roll 203, thereby allowing the adhesive to be applied to the nonwoven web in a uniform coat throughout the length and width of the web. The pressure at the nip between the backup roller 204 and the offset roll 203 is selected to be sufficient to provide proper transfer of the adhesive. Excess pressure should be avoided to prevent a substantial reduction in the thickness of the nonwoven web, if the thickness of the nonwoven web is important in its end use.

In a similar manner to the method of applying the hot melt adhesive to the nonwoven web using a rotogravure roll, FIG. 2C demonstrates the application of the hot melt adhesive to the creping roll using a rotogravure roll. In this method, a rotogravure applicator roller 112 is in communication with the reservoir 118 containing the hot melt adhesive 120. Again, heat is supplied to the hot melt adhesive in the reservoir 118 so that the hot melt adhesive is liquefied. The rotogravure roller 112 picks up the liquid hot melt adhesive 120 from the reservoir 118 and carries the hot melt adhesive 120 upward onto the surface of the roller 112 as it rotates. The rotogravure roller 112 contacts the creping roll 12, transferring the hot melt adhesive to the creping roll. A doctor blade 106 is provided to wipe or scrape off excess adhesive and to ensure that the adhesive 120 is uniformly covered on the rotogravure roller.

In a similar manner to the method of applying the hot melt adhesive to the nonwoven web using an offset roll, FIG. 2D demonstrates the application of the hot melt adhesive to the creping roll using an offset roller. A rotogravure applicator roller 212 is in communication with the reservoir 218 containing the hot melt adhesive 220 and carries the hot melt adhesive 220 upward onto the surface of the roller 212 as it rotates. The rotogravure roller 212 contacts and offset roll 213 and transfers the hot melt adhesive to the offset roll 213. The offset roll 213 then contacts the creping roll 12, transferring the holt melt adhesive to the creping roll. A doctor blade 206 is provided to wipe or scrape off excess adhesive and to ensure that the adhesive 220 is uniformly covered on the rotogravure roller 212, which in turn ensures a uniformly covering of the adhesive of the offset roll 213 and the creping roll 12.

Using a rotogravure roll or an offset roll has the advantage of being capable of applying a very uniform thin coating of the hot melt adhesive to the fibrous web of roll. However, spraying the hot met melt adhesive onto the nonwoven web or the creping roll can also accomplish this same result.

As is demonstrated in FIGS. 2A-D, the hot melt adhesive may be applied to the first side 11 of the nonwoven web 10 prior to contacting the first side 11 of the nonwoven web with the creping roll, or, in the alternative, an adhesive may be applied to the creping roll. It is not critical to the present invention whether the hot melt adhesive is applied to the nonwoven web or the creping roll. Nor is it critical to the present invention which method is used to apply the hot melt adhesive.

In the creping process of the present invention, the nonwoven web is at least partially coated on one side with an adhesive, so that about 5-100%, preferably about 10-70%, and more preferably about 25-50% of the total surface area on one side is coated of the nonwoven web is coated. Hence, about 0-95%, preferably about 30-90% and more preferably about 75-50% of the area of the nonwoven web is uncoated. In alternative, about 5-100%, preferably about 10-70%, and more preferably about 25-50% of the total surface area of the creping roll is coated. This translates to about 0-95%, preferably about 30-90% and more preferably about 75-50% of the area of the creping roll is uncoated. The thickness of the adhesive on the nonwoven web or creping roll determines the amount of adhesive which will be present on the nonwoven web. The weight amount of the adhesive on the nonwoven is called the “add-on”. Desirably, the amount of the add-on adhesive should be in the range of about 0.1% to about 10% by weight, based on the weight of the nonwoven web. Preferably, the amount of the adhesive add-on should be in the range of about 1% to about 3.5% by weight, based on the weight of the nonwoven web.

The nonwoven web 10 also possesses interfilament bonding, in the form of a pattern called a web bond pattern, which is imparted during manufacture of the nonwoven web. Typically, the bond pattern can be a thermal point bond pattern, point unbonded (PUB) or the like. In addition, the nonwoven web can be through-air bonded. The adhesive applied to the nonwoven web or the creping roll is typically concentrated to a greater extent at the interfilament-bond areas, causing still greater interfilament bonding in those areas. The thermoplastic nonwoven web is placed against a creping surface, such as a creping roll, and is peelably bonded to the creping surface. The creping surface is preferably heated, and is moved (e.g. rotated) in a machine direction of the nonwoven web. As the creping surface moves, the leading edge of the nonwoven web bonded to the surface is creped off the creping surface using a doctor blade.

Returning to the description of FIG. 1, once the nonwoven web 10 is adhered to the creping roll 12, the nonwoven web stays attached to the creping roll 12 as the creping roll rotates. The nonwoven web 10 is brought into contact with a doctor blade 14. The action of the creping blade 14 removes the adhered nonwoven web 10 from the creping roll 12. The doctor blade 14 penetrates the adhesive coating underneath the web and lifts the nonwoven web off the creping roll 12, resulting in permanent filament bending in the bonded areas corresponding to the nonwoven web bond pattern, a permanent looping of the filaments in the unbonded areas. Only one side of the nonwoven web is creped at this point, which results in a creped nonwoven web 18, having a controlled crepe on the nonwoven web.

In an alternative embodiment, the press roll 20 may have an embossing pattern. If the press roll has and embossing pattern, the nonwoven web 10 will be adhered to the creping roll 12 in the embossing pattern and the nonwoven web 10 will be creped from the creping roll according to the embossing pattern. In addition, one or more press rolls can be used, with none or one having an embossing pattern.

The creped nonwoven web 18 is then advanced by pull rolls 24 into a winder (not shown) to from a wound roll of the creped nonwoven web 22. Once rolled, the creped nonwoven web can be transferred to another location and further processed to form final products containing the creped nonwoven web. In alternative, although not shown in FIG. 1, the creped nonwoven web 18 could be further processed in-line to form a final product from the creped nonwoven web. An example of further processing includes, but is not limited to creping the second side 21 of the nonwoven web to form a nonwoven web which is creped on both sides.

When both sides of the nonwoven fibrous web are creped, the process of the first method further comprises

d) adhering the second side of the nonwoven web to a second creping roll by contacting the second side of the nonwoven fibrous web with the second roll using a hot melt adhesive to adhere the second side of the nonwoven fibrous web to the roll; and

e) removing nonwoven fibrous web adhered to the second creping roil by creping the nonwoven fibrous web from the second creping roll with a creping blade to produce a creped thermoplastic nonwoven web which is creped on both the first and second sides.

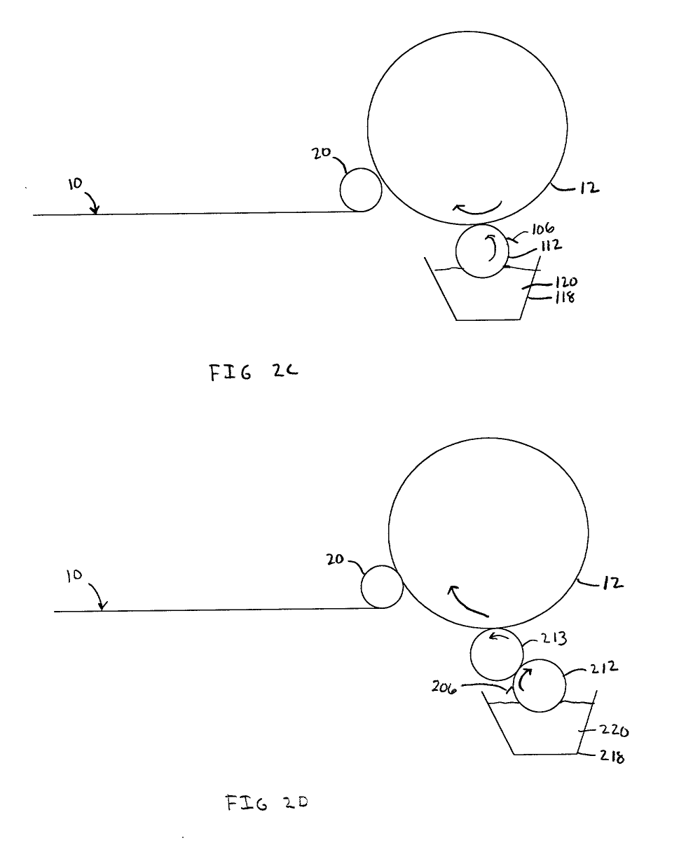

In FIG. 3, a process for producing a creped nonwoven web which has been creped on both sides of the web is shown. The process is similar to FIG. 1, but instead of rolling the creped nonwoven web 18, the second side 21 of the nonwoven web 10 is creped.

A first press roll 20 engages the first side 11 of the nonwoven web 10 with a first creping roll 12 by guiding the nonwoven web 10 onto the first creping roll 12. The first press roll 20 also supplies sufficient pressure to the nonwoven web 10 to adhere the nonwoven web 10 to the first creping roll 12. Again, it is pointed out that the hot melt adhesive must be applied to the first side of the nonwoven fibrous web or onto the creping roll 12 before the nonwoven web is contacted with the creping roll 12. The methods which can be used to apply the hot melt adhesive are described above and some of the methods are shown in FIGS. 2A-2D. The description of adhesive application process is given above.

Once the nonwoven web 10 is adhered to the first creping roll 12, the nonwoven web is brought into contact with a first creping blade 14 which removes the nonwoven web 10 from the creping roll 12. The resulting creped nonwoven web 18 has one side which is creped.

The once creped nonwoven web 18 is then advanced by pull rolls 24 to a second press roll 30 and a second creping roll 32. The second press roll 30 engages the nonwoven web 18 with the second creping roll 32 by guiding the creped nonwoven web 18 onto the second creping roll 32, such that the second side of the nonwoven web 10 is brought into contact with the second creping roll 32. Again, in order to adhere the nonwoven web to the creping roll, a hot melt adhesive must be applied to the second side 21 of the nonwoven fibrous web or the second creping roll 32. The methods which can be used to apply the hot melt adhesive are described above and some of the methods are shown in FIGS. 2A-2D. The description of adhesive application process is given above.

Once the once creped nonwoven web 18 is adhered to the second creping roll 32, the once creped nonwoven web is brought into contact with a second creping blade 34. The action of the second creping blade 34 removes the creped nonwoven web 18 from the second creping roll 32, which results in a twice creped nonwoven web 38, having a controlled crepe on both sided of the web.

The twice creped nonwoven web 38 is then advanced by pull rolls 24 into a winder (not shown) to from a wound roll of the creped nonwoven web 42. Once rolled, the creped nonwoven web 38 can be transferred to another location and further processed to form final products containing the creped nonwoven web. In alternative, although not shown in the figures, the twice creped nonwoven web 38 could be further processed in-line to form a final product from the twice creped nonwoven web.

In the processes shown in FIG. 1 and FIG. 3, which are described above, it is noted that either the hot melt adhesive is applied to the nonwoven web or to the creping roll and preferably not to both at the same time. However, applying the adhesive to both the nonwoven web and the creping roll is not outside the scope of the present invention.

In a second method of the present invention for preparing a creped thermoplastic fiber containing nonwoven web is accomplished by

a) providing an adhesive nonwoven fibrous web comprising thermoplastic fibers wherein the thermoplastic fibers comprise a thermoplastic polymer and an adhesive additive;

b) adhering the adhesive nonwoven fibrous web to a roll by contacting the adhesive nonwoven fibrous web with the roll; and

c) removing nonwoven fibrous web adhered to the first creping roll by creping the nonwoven fibrous web from the first roll with a creping blade to produce a creped thermoplastic nonwoven web.

In the second embodiment of the present invention, an adhesive does not have to be applied to the nonwoven web or the creping roll. This can be accomplished provided that the nonwoven web has some adhesive properties. In the practice of this aspect of the present invention, fibers and/or filaments of the nonwoven web are prepared from a blend of a thermoplastic polymer and an adhesive additive.

The adhesive additive can be any additive which will increase the adhesion of the nonwoven fibrous web to the creping roll. Examples of adhesive additives include, but are not limited to, tackifying resins, pressure sensitive adhesives, hot melt adhesive and the like. Any tackifying resin or pressure sensitive adhesive can be used. The only requirements for the adhesive additive is that the adhesive additive is compatible with the thermoplastic polymer and the adhesive additive can withstand the high processing (e.g., extrusion) temperatures. The term “compatible” is understood by those skilled in the art as to mean that the components of the mixture do not phase separate to any great degree once mixed. Further, the adhesive additive also needs to be compatible with other additives, such as processing aids, fillers and the like, which may be present in the thermoplastic polymeric composition used to prepare the fibers of the nonwoven fibrous web. As an alternative, however, the adhesive additive may be semi-compatible at the use temperature. When semi-compatible, the adhesive additive may be force to the polymer surface where it may be most effective. Ways to force the additive to the surface include heating the formed fibers. This heating may be supplied by any means known to those skilled in the art, including heating the creping roll and using an external heat source.

Generally, hydrogenated hydrocarbon resins are preferred tackifying resins, because of their better temperature stability. REGALREZ® and ARKON® P series tackifiers are examples of hydrogenated hydrocarbon resins. ZONATAC®501 is an example of a terpene hydrocarbon. REGALREZ® hydrocarbon resins are available from Hercules Incorporated and are fully hydrogenated α-methyl styrene-type low molecular weight hydrocarbon resins, produced by polymerization and hydrogenation of pure monomer hydrocarbon feed stocks. Grades 1094, 3102, 6108 and 1126 are highly stable, light-colored low molecular weight, nonpolar resins suggested for use in plastics modification. ARKON P series resins are available from Arakawa Chemical (U.S.A.) Incorporated. ZONATAC®501 lite resin, a product of Arizona Chemical Co., has a softening point of 105° C., a Gardner color 1963 (50% in heptane) of 1 and a Gardener color neat (pure) (50% in heptane); APHA color=70) of water white, a specific gravity (25°/25° C.) of 1.02 and a flash point (closed cup, ° F.) of 480° F. Of course, the present invention is not limited to use of such three tackifying resins, and other tackifying resins which are compatible with the thermoplastic components of the nonwoven web and can withstand the high processing temperatures, can also be used. Examples of other tackifying resins are given U.S. Pat. Nos. 4,789,699, 4,294,936 and 3,783,072, the contents of which, with respect to the tackifier resins, are incorporated herein by reference.

A pressure sensitive elastomer adhesive may include, for example, from about 40 to about 80 percent by weight elastomeric polymer, from about 5 to about 40 percent polyolefin and from about 5 to about 40 percent resin tackifier. For example, a particularly useful composition included, by weight, about 61 to about 65 percent KRATON® G-1657, about 17 to about 23 percent Polyethylene NA-601, and about 15 to about 20 percent REGALREZ® 1126.

In addition, the adhesive additive may be polymers which are inherently tacky, such as polybutene, polybutylene and the like. Again, it is important to note that the adhesive additive should be compatible, or at least semi-compatible, with the thermoplastic polymer used to prepare the fiber and/or filaments of the nonwoven web. Commercial examples of adhesive additives include, but are not limited to Shell 8911, Shell DP 8611 and Shell SP 8510, both are available from Shell Chemical, Houston, Tex.

The adhesive additive can be blended with the thermoplastic polymer at any time during the processing of the thermoplastic polymer, but must be added to the thermoplastic polymer before the thermoplastic polymer is spun into a fiber or filament. Preferably, the adhesive additive is blended with the thermoplastic polymer in the extruder.

Generally, the adhesive additive is added in amount of about 0.5 to about 15 parts by weight based on the weight of the thermoplastic polymer. Preferably, the adhesive additive should be about 1 to about 10 parts by weight, and more preferably about 2 to about 7 parts by weight.

In addition to the adhesive additive, other additives, such as processing aids, filler, pigments, slip agents and the like, may be also be added to the thermoplastic polymer.

The second method of the present invention is practiced with the same equipment shown in FIG. 1. The only difference is an external hot melt adhesive is not placed on the creping roll or the nonwoven web. Therefore, the process of the second method of the present invention will not be described in detail as it relates to FIG. 1.

In addition, as in the first method of the present invention, the creped nonwoven web 18 produce in accordance with the second method of the present invention could be further processed in-line to form a final product from the creped nonwoven web. An example of further processing includes, but is not limited to creping the second side 21 of the nonwoven web to form a nonwoven web which is creped on both sides.

When both sides of the nonwoven fibrous web are creped in accordance with the second method of the present invention, the process of the second method further comprises:

d) adhering the second side of the nonwoven web to a second roll by contacting the second side of the adhesive nonwoven fibrous web with the second roll; and

e) removing nonwoven fibrous web adhered to the second roll by creping the adhesive nonwoven fibrous web from the second roll with a creping blade to produce a creped thermoplastic nonwoven web which is creped on both the first and second sides.

In the creping processes of the present invention, the press rolls can have a smooth surface or can have an embossing pattern. A press roll with a smooth surface will essentially press the entire nonwoven web to the creping roll, resulting in the essentially the entire surface of the nonwoven web being adhered to the creping roll. An embossing roll has raised portions which will contact the nonwoven web, pressing the nonwoven web into the creping roll. In addition, the embossing roll will have recessed portions which will not press the nonwoven web into the creping roll. Generally, the embossing press roll can be in the form of discrete shapes or can have a regular repeating pattern, such as a reticular net-like pattern. The press rolls can have patterns typically used to bond nonwoven webs. Press rolls are typically unheated. If the press roll has an embossing pattern, the nonwoven web will be adhered to the creping roll according to the embossing pattern. When a pattern is embossed into the nonwoven web and the nonwoven web is adhered to the creping surface according to the embossing pattern, only the portions of the web that have been embossed with the raised portions of the embossing press roll will be creped from the creping roll. When both sides of the nonwoven web are creped, none, one or both of the press rolls can have an embossing pattern.

The doctor blade used in the process of the present invention can be made of various materials including, but not limited to, ceramic coated steel, spring steel and brass. The blade is typically cut at an angle ranging from about 5 to about 45 degrees. Preferably, the doctor blade is cut at an angle in the range of about 10 to about 25 degrees. In addition, the tension of the blade against the creping roll should be in the range of about 5 to about 150 pounds per linear inch.

When a hot melt adhesive is used to adhere the nonwoven fibrous web and a rotogravure applicator roll is used alone or in combination with offset roll, the rotogravure applicator roll can have a smooth surface or can have a patterned surface. A rotogravure applicator roll with a smooth surface will essentially coat the entire nonwoven web or the creping roll with the hot melt adhesive. This will result in essentially the entire surface of the nonwoven web being adhered to the creping roll. When creped from the creping roll, essentially the entire surface of the nonwoven fibrous web will be creped. When the rotogravure applicator roll has a pattern, the adhesive to be applied to the nonwoven web or the creping roll in this pattern. As a result the nonwoven web will adhere to the creping roll in the pattern of the rotogravure roll and hence creped in this pattern.

The creping rolls used in the present invention can be a standard Yankee drum or can be a smooth roll. In addition, the rolls can be heated, chilled or at or about ambient temperature. From the standpoint of operating cost, it is preferred that the creping roll is at ambient temperature, however, the actual temperature in which the creping roll is operated depends on many factors, including, but not limited to, whether a hot melt adhesive or an adhesive additive is processed with the thermoplastic polymers.

Typically, the level of creping achieved using the process of the present invention is in the range of about 1 to about 75%. Generally, however, the level of creping is in the range of about 5 to about 50%, more preferably, between about 10 and about 40%.

The creped nonwoven webs produced by the process of the present invention have improved permeability, conductance, and a larger pore volume as compared to the uncreped nonwoven web. In addition the density of the creped nonwoven web is less than the uncreped nonwoven web and the creped nonwoven web has a greater thickness than the uncreped nonwoven. Finally, the creped nonwoven webs of the present invention typically exhibit a low initial modulus, almost in the elastic region, up to an elongation about equal to the crepe level.

The creped nonwoven web of the present invention can be used as wipes, liners, transfer or surge layers, outercovers, other fluid handling materials and looped attachment materials for hook and loop fasteners.

### EXAMPLES

### Example 1

Using the process shown in FIG. 1, a bonded spunbond having a basis weight of 0.4 osy and about 3.5 denier fiber produced from polypropylene (Exxon 3155) was supplied to the process. A hot-melt adhesive NS 34-2950, available from Nations Starch and Chemical was sprayed onto a smooth creping roll through a spray head having 30 holes per liner inch, each hole having about 0.020 inch diameter. The spray rate was such that the nonwoven web had about a 2% to about 3% by weight adhesive add-on. A press roll applying a pressure of about 35 pounds per linear inch adhered the spunbond nonwoven web to the creping roll. The creping roll was heated to a surface temperature in the range of 145° F. to 155° F. A spring steel doctor blade applied about 15 pound per linear inch. The resulting nonwoven web was successfully creped to a crepe level of 37% with a 3% by weight adhesive add-on.

### Example 2

The procedure of Example 1 was repeated, however a larger press roll was used at the top of the creping roll. The larger steel press roll applied a pressure to nonwoven web in the range of about 800 to 1100 pound per linear inch. The resulting nonwoven web was successfully creped to a crepe level of 37% with a 3% by weight adhesive add-on.

While the invention has been described in detail with respect to specific embodiments thereof, it will be apparent to those skilled in the art that various alterations, modifications and other changes may be made without departing from the spirit and scope of the present invention. It is therefore intended that all such modifications, alterations and other changes be encompassed by the claims.

We claim:

1. A method for producing a creped nonwoven web containing thermoplastic fibers, said method comprising
a) providing a nonwoven fibrous web having a first side and a second side, wherein the nonwoven fibrous web comprises thermoplastic fibers;
b) adhering the first side of the nonwoven fibrous web to a first roll by contacting the nonwoven fibrous web with the first roll using a hot melt adhesive to adhere the nonwoven fibrous web to the first roll; and
c) removing nonwoven fibrous web adhered to the first roll by creping the nonwoven fibrous web from first roll with a creping blade to produce a creped nonwoven web.

2. The method of claim 1, wherein the hot melt adhesive is placed on the first roll prior to the contacting of the nonwoven fibrous web with the first roll.

3. The method of claim 2, wherein the hot melt adhesive is placed on the first roll by a method selected from the group consisting of printing, spraying and dipping.

4. The method of claim 1, wherein the hot melt adhesive is placed on the first side of the nonwoven fibrous web prior to the contacting of the nonwoven fibrous web with the first roll.

5. The method of claim 4, wherein the hot melt adhesive is placed on the first side of the nonwoven web by a method selected from the group consisting of printing, spraying and dipping.

6. The method of claim 1, wherein the hot melt adhesive has a melting point in the range of about 60° C. to about 200° C.

7. The method of claim 6, wherein the hot melt adhesive has a melting point in the range of about 60° C. to about 125° C.

8. The method of claim 1, wherein the hot melt adhesive is applied to the nonwoven web in an amount of about 0.1 to 10% by weight, based on the weight of the nonwoven web..

9. The method of claim 8, wherein the hot melt adhesive is applied to the nonwoven web in an amount of about 1.0 to 3.5% by weight, based on the weight of the nonwoven web..

10. The method of claim 1, wherein in the first roll comprises a smooth roll.

11. The method of claim 1, wherein the first roll is at or about ambient temperature.

12. The method of claim 1, wherein the first roll is heated above ambient temperature.

13. The method of claim 1, wherein the hot melt adhesive is hydrophobic.

14. The method of claim 1, further comprising
d) adhering the second side of the nonwoven web to a second roll by contacting the second side of the nonwoven fibrous web with the second roll using a hot melt adhesive to adhere the second side of the nonwoven fibrous web to the roll; and
e) removing nonwoven fibrous web adhered to the second roll by creping the nonwoven fibrous web from the second roll with a creping blade to produce a creped thermoplastic nonwoven web which is creped on both the first and second sides.

15. The method of claim 14, wherein in the second roll comprises a smooth roll.

16. The method of claim 14, wherein the second roll is at or about ambient temperature.

17. The method of claim 14, wherein the second roll is heated above ambient temperature.

18. A method for producing a creped nonwoven web containing thermoplastic fibers, said method comprising
a) providing an adhesive nonwoven fibrous web having a first side and a second side comprising thermoplastic fibers wherein the thermoplastic fibers comprise a thermoplastic polymer and an adhesive additive;
b) adhering the adhesive nonwoven fibrous web to a first roll by contacting the adhesive nonwoven fibrous web with the first roll; and
c) removing nonwoven fibrous web adhered to the first roll by creping the nonwoven fibrous web from the first roll with a creping blade to produce a creped thermoplastic nonwoven web.

19. The method of claim 18, wherein in the first roll is a smooth roll.

20. The method of claim 18, wherein the first roll is at or about ambient temperature.

21. The method of claim 18, wherein the first roll is heated above ambient temperature.

22. The method of claim 18, further comprising
d) adhering the second side of the nonwoven web to a second roll by contacting the second side of the adhesive nonwoven fibrous web with the second roll; and
e) removing nonwoven fibrous web adhered to the second roll by creping the adhesive nonwoven fibrous web from the second roll with a creping blade to produce a creped thermoplastic nonwoven web which is creped on both the first and second sides.

23. The method of claim 22, wherein in the second roll is a smooth roll.

24. The method of claim 22, wherein the second roll is at or about ambient temperature.

25. The method of claim 22, wherein the second roll is heated above ambient temperature.
